(19) United States
(12) Patent Application Publication
(10) Pub. No.: US 2025/0076942 A1
(43) Pub. Date: Mar. 6, 2025

(54) Solid State Storage Device and Method for Dynamic Temperature Control Thereof

(71) Applicant: KIOXIA CORPORATION, Minato-ku, Tokyo (JP)

(72) Inventor: Cheng Hsiu CHEN, Hsinchu (TW)

(73) Assignee: KIOXIA CORPORATION, Minato-ku, Tokyo (JP)

(21) Appl. No.: 18/678,453

(22) Filed: May 30, 2024

(30) Foreign Application Priority Data
Sep. 4, 2023 (CN) 202311133009.5
Sep. 4, 2023 (TW) 112133511

(51) Int. Cl. G06F 1/20

(52) U.S. Cl. CPC G06F 1/206

(57) ABSTRACT

A solid-state storage device is provided, which includes a non-volatile memory, a temperature sensor, and a controller. The temperature sensor is configured to periodically detect a current temperature of the non-volatile memory. The controller is configured to periodically obtain the current temperature from the temperature sensor. The controller is configured to activate a dynamic temperature control mechanism of the solid-state storage device. The dynamic temperature control mechanism includes a temperature control state table having a plurality of temperature control states and their corresponding state values. The controller is further configured to calculate a temperature difference value between the current temperature and a previous temperature of the non-volatile memory, and accumulate the temperature difference value to obtain a temperature accumulation value. The controller is further configured to determine a current temperature control state from the temperature control state table according to the temperature accumulation value.

### CROSS-REFERENCE TO RELATED APPLICATION(S)

The present application is based on, and claims priority from, Taiwan Application Serial Number 112133511, filed on Sep. 4, 2023, and China Application Serial Number 202311133009.5, filed on Sep. 4, 2023, the disclosures of which are hereby incorporated by reference herein in their entirety.

### FIELD OF THE DISCLOSURE

The present disclosure relates to solid-state storage devices, and, in particular, a solid-state storage device and a dynamic temperature control method thereof.

### BACKGROUND

With industry advances, solid-state storage devices have been widely used in various computer systems, and their performance has steadily improved. However, such progress can create overheating problems. Conventional solid-state storage devices typically utilize a single fixed-temperature threshold. When a device exceeds this threshold, performance is reduced to lower temperature. Effective balance between temperature control and performance optimization is thus desirable.

### SUMMARY OF THE DISCLOSURE

Accordingly, a solid-state storage device and dynamic temperature control method thereof are provided to address the problems noted.

In an aspect of the present disclosure, a solid-state storage device is provided, which includes a non-volatile memory, a temperature sensor, and a controller. The temperature sensor is configured to periodically detect a current temperature of the non-volatile memory. The controller is electrically connected to the temperature sensor and the non-volatile memory. The controller is configured to periodically obtain the current temperature from the temperature sensor. The controller is configured to activate a dynamic temperature control mechanism of the solid-state storage device. The dynamic temperature control mechanism includes a temperature control state table having a plurality of temperature control states and their corresponding state values. The controller is further configured to calculate a temperature difference value between the current temperature and a previous temperature of the non-volatile memory, and accumulate the temperature difference value to obtain a temperature accumulation value. The controller is further configured to determine a current temperature control state from the temperature control state table according to the temperature accumulation value.

In another aspect of the present disclosure, a dynamic temperature control method for use in a solid-state storage device is provided. The solid-state storage device includes a controller, a temperature sensor, and a non-volatile memory. The method includes utilizing the temperature sensor to periodically detect a current temperature of the non-volatile memory; utilizing the controller to periodically obtain the current temperature from the temperature sensor; utilizing the controller to activate a dynamic temperature control mechanism of the solid-state storage device, wherein the dynamic temperature control mechanism comprises a temperature control state table having a plurality of temperature control states and their corresponding state values; utilizing the controller to calculate a temperature difference value between the current temperature and a previous temperature of the non-volatile memory, and to accumulate the temperature difference value to obtain a temperature accumulation value; and utilizing the controller to determine a current temperature control state from the temperature control state table according to the temperature accumulation value.

### BRIEF DESCRIPTION OF THE DRAWINGS

Aspects of the present disclosure are best understood from the following detailed description when read with the accompanying figures. It is noted that in accordance with the standard practice in the industry, various features are not drawn to scale. In fact, the dimensions of the various features may be arbitrarily increased or reduced for clarity of discussion.

FIG. 1 is a block diagram illustrating a computer system in accordance with an embodiment of the present disclosure.

FIG. 2 is a diagram of a multistage temperature control method in accordance with an embodiment of the present invention.

FIG. 3 is a flowchart of a dynamic temperature control method for use in a solid-state storage device in accordance with another embodiment of the present invention.

FIG. 4 is a diagram illustrating performance comparison between the methods in the embodiments of FIG. 2 and FIG. 3.

FIG. 5 is a diagram illustrating temperature comparison between the methods in the embodiments of FIG. 2 and FIG. 3.

### DETAILED DESCRIPTION

The following description is for the purpose for describing preferred embodiments of the present disclosure, with the aim of describing the basic spirit of the present disclosure, but not to limit the present disclosure. The actual content of the disclosure should be referred to the appended claims.

It should be understood that the words “comprising” and “including” used in this specification are used to indicate the existence of specific technical features, numerical values, method steps, work processes, elements and/or components, but not to exclude additional technical features, numerical values, method steps, operations, elements, components, or any combination thereof.

The use of words such as “first”, “second”, and “third” in the scope of the patent application are used to modify the elements in the scope of the patent application, and are not used to indicate the priority order or precedence relationship between them, one component precedes another component, or the time sequence in which method steps are executed, and is only used to distinguish components with the same name.

The term “configured to” may describe or claim that various units, circuits, or other components are “configured to” perform a task or tasks. In such contexts, the term “configured to” is used by indicating that the units/circuits/components include a structure (e.g., circuitry) that performs their task(s) during operation. Thus, a specified unit/circuit/component may be said to be configured to perform the task even when the unit/circuit/component is not currently operating (e.g., not turned on). Such units/circuits/components used with the term “configured to” include hardware—for example: circuits, memory (which stores program commands that are executable to perform operations), etc. Additionally, “configured to” may include a generic structure (e.g., general circuitry) that is manipulated by software and/or firmware (e.g., an FPGA or a general-purpose processor executing the software) to operate in a manner that enables the execution of the task(s) to be solved. The term “configured to” may also include adapting a manufacturing process (e.g., a semiconductor manufacturing equipment) to produce a device (e.g., an integrated circuit) adapted to implement or perform one or more tasks.

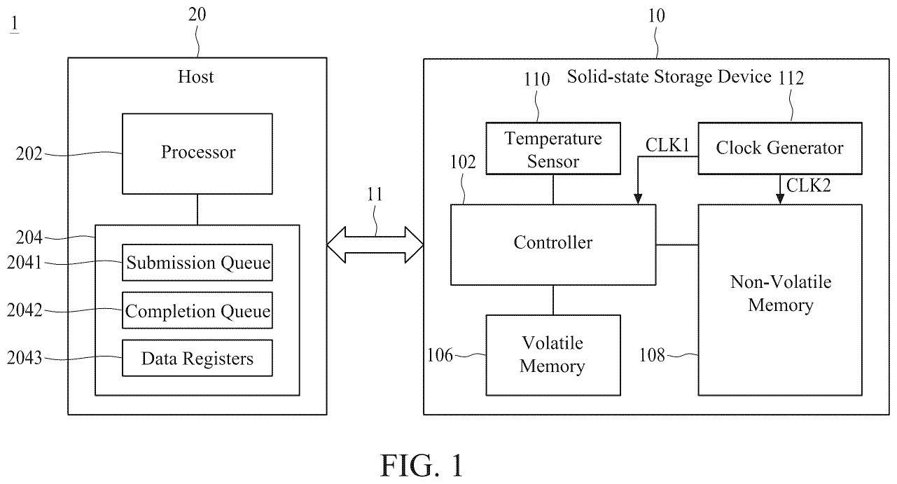

FIG. 1 is a block diagram illustrating a computer system in accordance with an embodiment of the present disclosure.

As shown in FIG. 1, the computer system 1 may include a solid-state storage device 10 and a host 20. The solid-state storage device 10 may be electrically connected to the host 20 through bus 11 for command and data transmission. In some embodiments, bus 11 may be a Universal Serial Bus (USB), a Serial Advanced Technology Attachment (SATA) bus, or a Peripheral Component Interconnect Express (PCI Express, PCIe) bus, etc., but the disclosure is not limited thereto.

The solid-state storage device 10 may include a controller 102, a volatile memory 106, a non-volatile memory 108, a temperature sensor 110, and a clock generator 112. The controller 102 may be electrically connected to the volatile memory 106 and the non-volatile memory 108, and used to control data access of the volatile memory 106 and the non-volatile memory 108. In some embodiments, the controller 102 may be, for example, a general-purpose processor, a microcontroller, an application-specific integrated circuit (ASIC), or a field programmable gate array (FPGA), etc., but the present disclosure is not limited thereto.

The volatile memory 106 may include, for example, a dynamic random access memory (DRAM) and/or a static random access memory (SRAM), but the disclosure is not limited thereto. In some embodiments, the volatile memory 106 may be disposed outside the controller 102. In some other embodiments, the volatile memory 106 may be integrated into the controller 102. The non-volatile memory 108 may be, for example, a NAND flash memory storing write data provided by the host 20.

In some embodiments, the temperature sensor 110 is configured to periodically detect the temperature information (e.g., current temperature) of the non-volatile memory 108, and report the detected temperature information to the controller 102. The clock generator 112 is configured to provide a first clock signal CLK1 and a second clock signal CLK2 to the controller 102 and the non-volatile memory 108, respectively. Since the operating frequency of the controller 102 is usually higher than that of the non-volatile memory 108, the clock generator 112 can provide the first clock signal CLK1 and the second clock signal CLK2 of different frequencies respectively to the controller 102 and the non-volatile memory 108, wherein the frequency of the first clock signal CLK1 is higher than the second clock signal CLK2. In addition, when the solid-state storage device 10 enters any temperature control state, the controller 102 can control the frequency division ratio or the number of steps of the first clock signal CLK1 and the second clock signal CLK2, thereby reducing the frequency of the first clock signal CLK1 and the second clock signal CLK2 to reduce the temperature of the solid-state storage device 10.

The host 20 may include, for example, a processor 202 electrically connected to a system memory 204. In some embodiments, the processor 202 includes, for example, a central processing unit, a general-purpose processor, a microprocessor, etc., but the disclosure is not limited thereto. In addition, the processor 202 includes a controller (not shown) for controlling data access to the system memory 204. The system memory 204 includes, for example, a dynamic random access memory, but the disclosure is not limited thereto.

In some embodiments, the host 20 can support the Non-Volatile Memory Express (NVME) protocol, and the system memory 204 may be equipped with a submission queue 2041, a completion queue 2042, and data registers 2043. The submission queue 2041 may be configured to record the access commands issued by the processor 202, and the completion queue 2042 may be configured to record the status of the completed access commands from the solid-state storage device 10. The data registers 2043 may be configured to store data to be written to the solid-state storage device 10 by the host 20 and data read from the solid-state storage device 10 by the host 20.

The non-volatile memory 108 may include a plurality of blocks, and each block may include a plurality of pages. For example, non-volatile memory 108 can include 1024 blocks, and each block can include 64 pages, with capacity of each page 16 KB and each block 1 MB. The aforementioned data is for purposes of description, and the manufacturer of the non-volatile memory 108 can determine the number of pages in each block and the capacity of each page.

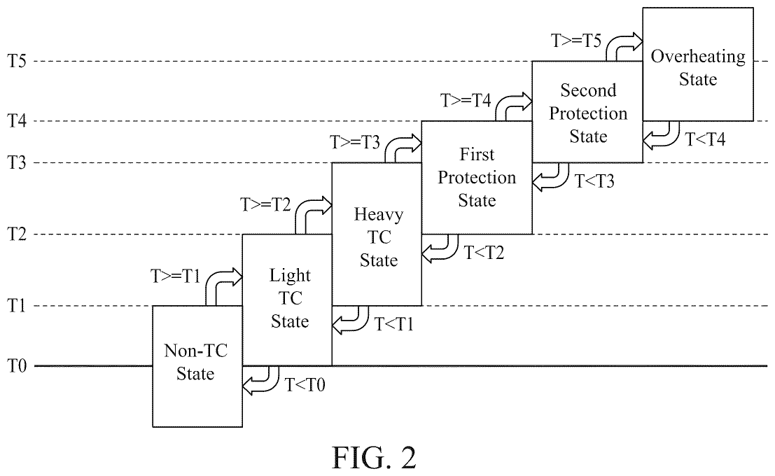

FIG. 2 is a diagram of a multistage temperature control method in accordance with an embodiment of the present invention. Please refer to both FIG. 1 and FIG. 2.

In an embodiment, the temperature control mechanism of the solid-state storage device 10 includes a non-temperature control (or non-TC) state and a plurality of temperature control (or TC) states. The temperature control states can be divided into a light temperature control state, a heavy temperature control state, a first protection state, a second protection state, and an overheating state. The controller 102 can set a plurality of temperature thresholds (e.g., TO to T5) to switch between the aforementioned non-temperature control state and the temperature control states, wherein the aforementioned temperature thresholds T0 to T5 can be designed according to practical needs. In addition, overheating protection measures corresponding to different temperature control states may vary, and the overheating protection measures corresponding to the light temperature control state to the overheating state will also become stricter, that is, performance of the solid-state storage device 10 will decrease. For example, the difference between the light temperature control state and the heavy temperature control state can be the frequency division ratios of the first clock signal CLK1 differing from the second clock signal CLK2, with the heavy temperature control state having a higher frequency division ratio. In the first protection state, the controller 102 may add additional overheating protection measures, such as delaying retrieval of access commands from the host 20 and delaying output of access commands to the non-volatile memory 108. In the second protection state, the controller 102 may add more overheating protection measures, such as stopping the retrieval of access commands from the host 20 or stopping the execution of retrieved access commands. In the overheating state, the controller 102 may add additional overheating protection measures, such as halting the execution of background firmware events including operations of garbage collection and erasing virtual blocks, and so on. It should be noted that the overheat protection measures described for the aforementioned temperature control states are for descriptive purposes, and the present disclosure is not limited thereto.

The temperature sensor 110 can periodically detect the current temperature T of the non-volatile memory 108 and report it to the controller 102. The controller 102 can determine the temperature control state of the solid-state storage device 10 based on the current temperature T of the non-volatile memory 108. In the first scenario, the current temperature T of the non-volatile memory 108 gradually increases from the temperature threshold TO. When the controller 102 determines that the current temperature T is lower than the temperature threshold T1, the controller 102 directs the solid-state storage device 10 to maintain a non-temperature control state. When the controller 102 determines that the current temperature T is higher than or equal to the temperature threshold T1 and is lower than the temperature threshold T2, the controller 102 directs the solid-state storage device 10 to enter the light temperature control state from the non-temperature control state. When the controller 102 determines that the current temperature T is higher than or equal to the temperature threshold T2 and is lower than the temperature threshold T3, the controller 102 directs the solid-state storage device 10 to enter the heavy temperature control state from the light temperature control state. When the controller 102 determines that the current temperature T is higher than or equal to the temperature threshold T3 and is lower than the temperature threshold T4, the controller 102 directs the solid-state storage device 10 to enter the first protection state from the heavy temperature control state. When the controller 102 determines that the current temperature T is higher than or equal to the temperature threshold T4 and is lower than the temperature threshold T5, the controller 102 directs the solid-state storage device 10 to enter the second protection state from the first protection state. When the controller 102 determines that the current temperature T is higher than or equal to the temperature threshold T5, the controller 102 directs the solid-state storage device 10 to enter the overheating state from the second protection state.

In the second scenario, the solid-state storage device 10 is in the overheating state, and the current temperature T of the non-volatile memory 108 gradually decreases from the temperature threshold T5. When the controller 102 determines that the current temperature T is lower than the temperature threshold T4 and higher than or equal to the temperature threshold T3, the controller 102 directs the solid-state storage device 10 to enter the second protection state from the overheating state. When the controller 102 determines that the current temperature T is lower than the temperature threshold T3 and higher than or equal to the temperature threshold T2, the controller 102 directs the solid-state storage device 10 to enter the first protection state from the second protection state. When the controller 102 determines that the current temperature T is lower than the temperature threshold T2 and higher than or equal to the temperature threshold T1, the controller 102 directs the solid-state storage device 10 to enter the heavy temperature control state from the first protection state. When the controller 102 determines that the current temperature T is lower than the temperature threshold T1 and higher than or equal to the temperature threshold TO, the controller 102 directs the solid-state storage device 10 to enter the light temperature control state from the heavy temperature control state. When the controller 102 determines that the current temperature T is lower than the temperature threshold TO, the controller 102 directs the solid-state storage device 10 to enter the non-temperature control state from the light temperature control state.

It should be noted that when the solid-state storage device 10 is actually operating, the temperature of the non-volatile memory 108 does not necessarily increase or decrease according to the first scenario or the second scenario. That is, the temperature control state of the solid-state storage device 10 is determined based on the increase or decrease of the current temperature T and the temperature threshold interval into which the current temperature T falls, thereby determining the current temperature control state. For example, assuming that the solid-state storage device 10 is already in a heavy temperature control state, when the controller 102 determines that the current temperature T of the non-volatile memory 108 is higher than or equal to the temperature threshold T3 and is lower than the temperature threshold T4, the controller 102 directs the solid-state storage 10 to enter the first protection state from the heavy temperature control state. If the overheat protection measures corresponding to the first protection state effectively reduce the temperature of the non-volatile memory 108, the current temperature T reported by the temperature sensor 110 to the controller 102 will also gradually decrease. When the controller 102 determines that the current temperature T of the non-volatile memory 108 is lower than the temperature threshold T2 and higher than the temperature threshold T1, the controller 102 directs the solid-state storage device 10 to return to the heavy temperature control state from the first protection state. Similarly, if the overheat protection measures corresponding to the heavy temperature control state can effectively reduce the temperature of the non-volatile memory 108, the current temperature T reported by the temperature sensor 110 to the controller 102 will also gradually decrease. When the controller 102 determines that the current temperature T of the non-volatile memory 108 is lower than the temperature threshold T1 and higher than the temperature threshold TO, the controller 102 directs the solid-state storage device 10 to enter the light temperature control state from the heavy temperature control state.

The multistage temperature control method in the aforementioned embodiment in FIG. 2 sets multiple temperature thresholds and their corresponding temperature control states. The current temperature control state is determined based on the detected current temperature T, thereby lowering the temperature of the non-volatile memory 108. This method can effectively balance cooling and performance with gradual changes in temperature. However, sudden changes in temperature, such as a rapid rise from the temperature threshold T1 to T4 in a short period of time, can cause the non-volatile memory 108 to switch directly from the light temperature control state to the second protection state, resulting in a significant decrease in performance. In response thereto, the present disclosure introduces a dynamic temperature control method for solid-state storage devices. This method utilizes a temperature control state table and using the temperature accumulation value Tacc to determine the current temperature control state, preventing sudden temperature changes from disrupting the balance between cooling and performance.

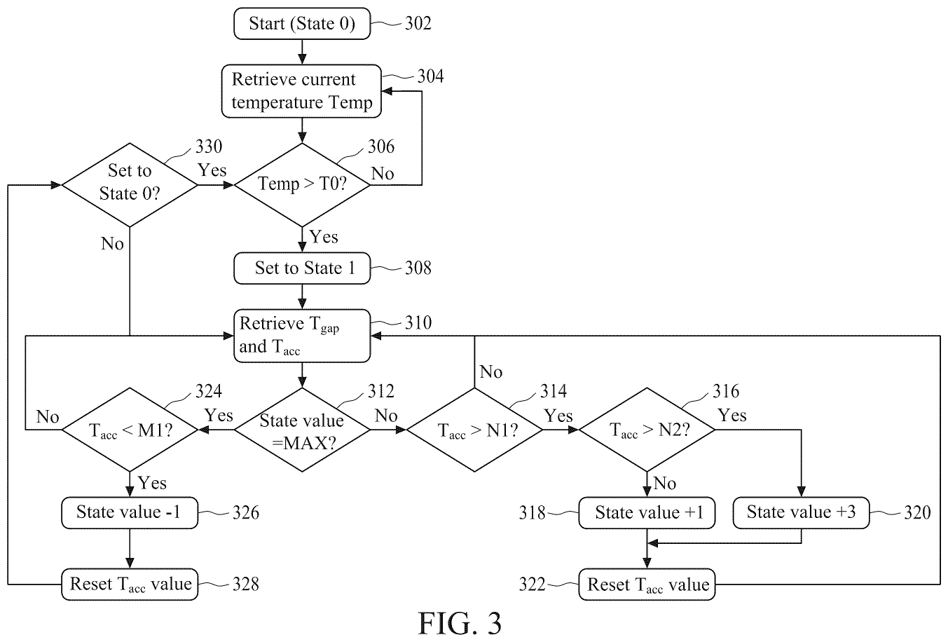

FIG. 3 is a flowchart of a dynamic temperature control method for use in a solid-state storage device in accordance with another embodiment of the present invention. Please refer to both FIG. 1 and FIG. 3.

In an embodiment, the solid-state storage device 10 includes a temperature control state table, as shown in Table 1. The temperature control state table includes a non-temperature control state (state 0) and a plurality of temperature control states, wherein the temperature control states include at least six states, and each temperature control state has a corresponding state value and overheating protection measures. In the embodiment of Table 1, the temperature control states include state 1 to state 19, and each state has corresponding overheat protection measures as shown.

TABLE 1

| | | | | Trans- | Abort | Halt | Halt |
|---|---|---|---|---|---|---|---|
| State | CLK1 | CLK2 | Reception | mittal | host | FW | FW |
| value | Step | Step | delay | delay | command | events 1 | events 2 |
| 0 | 1 | 1 | No | No | No | No | No |
| 1 | 2 | 2 | No | No | No | No | No |
| 2 | 3 | 3 | No | No | No | No | No |
| 3 | 4 | 4 | No | No | No | No | No |
| 4 | 5 | 5 | No | No | No | No | No |
| 5 | 6 | 6 | No | No | No | No | No |
| 6 | 7 | 7 | No | No | No | No | No |
| 7 | 8 | 8 | No | No | No | No | No |
| 8 | 9 | 9 | No | No | No | No | No |
| 9 | 10 | 10 | No | No | No | No | No |
| 10 | 11 | 11 | No | No | No | No | No |
| 11 | 12 | 12 | No | No | No | No | No |
| 12 | 13 | 13 | No | No | No | No | No |
| 13 | 14 | 14 | No | No | No | No | No |
| 14 | 15 | 15 | No | No | No | No | No |
| 15 | 16 | 16 | No | No | No | No | No |
| 16 | 16 | 16 | Yes | No | No | No | No |
| 17 | 16 | 16 | Yes | Yes | No | No | No |
| 18 | 16 | 16 | Yes | Yes | Yes | No | No |
| 19 | 16 | 16 | Yes | Yes | Yes | Yes | Yes |

In some embodiments, the step numbers of the first clock signal CLK1 and the second clock signal CLK2 in Table 1 represent frequency division ratios thereof. In other embodiments, the number of steps of the first clock signal CLK1 and the second clock signal CLK2 in Table 1 represents the frequency reduction ratio corresponding to the number of steps. Specifically, in Table 1, state 0 represents the full-speed operating state, with the step numbers of the first clock signal CLK1 and the second clock signal CLK2 being 1, indicating that the controller 102 and the non-volatile memory 108 can operate at full speed. As the state value increases from 1 to 15 (e.g., from state 1 to state 15), the number of steps of the first clock signal CLK1 and the second clock signal CLK2 also increases. In other words, as the state value increases from 1 to 15, the frequencies of the first clock signal CLK1 and the second clock signal CLK2 decrease. From state 16 to state 19, the frequencies of the first clock signal CLK1 and the second clock signal CLK2 remain the same as those in state 15.

In addition to lowering the frequency of the first clock signal CLK1 and the second clock signal CLK2, the controller 102 implements additional overheat protection measures from state 16 to state 19 to further reduce the temperature of the non-volatile memory 108 or the solid state storage device 10. For example, state 16 is the fourth highest state. Compared to state 15, state 16 will activate an additional overheat protection measure that increases the reception delay, indicating that the delay time for the controller 102 to retrieve access commands from the host 20 is increased. State 17 is the third highest state. Compared to state 16, state 17 will activate an additional overheat protection measure that increases the transmittal delay, indicating that the delay time for the controller 102 to send access commands to the non-volatile memory 108 is increased.

State 18 is the second highest state. Compared to state 17, state 18 will activate an additional overheat protection measure of aborting the host commands. For example, aborting the host command can indicate that the controller 102 may stop retrieving access commands from the host 20 or stop executing the retrieved access commands. For example, state 19 is the highest state. Compared to state 18, state 19 will activate additional overheat protection measures for halting firmware (FW) events 1 and firmware events 2, where the aforementioned firmware events 1 and firmware events 2 represent firmware events executed in the background, such as garbage collection and erasing virtual blocks, etc. It should be noted that halting of firmware events 1 and 2 in state 19 is for descriptive purposes and the disclosure is not limited thereto. In addition, the number of temperature control states and the corresponding overheat protection measures included in each temperature control state within Table 1 are for descriptive purposes, and the present disclosure is not limited thereto.

If the non-temperature control state and various temperature control states described in the embodiment of FIG. 2 are compared with the temperature control state table (e.g., Table 1) of the embodiment of FIG. 3, the non-temperature control state, light temperature control state, heavy temperature control state, the first protection state, the second protection state, and the overheating state in the embodiment of FIG. 2 may, for example, correspond to state 0, state 8, state 11, state 17, state 18, and state 19 in the temperature control table (e.g., Table 1) in the embodiment of FIG. 3. The dynamic temperature control method in FIG. 3 sets more temperature control states, and uses the temperature accumulation value Tacc to determine the current temperature control state, as follows.

Please refer to both FIG. 1 and FIG. 3. In step 302, the process starts, and the solid-state storage device 10 is in state 0. In step 304, the controller 102 obtains the current temperature Temp of the non-volatile memory 108 from the temperature sensor 110. In step 306, the controller 102 determines whether the current temperature Temp is higher than the temperature threshold TO. When the controller 102 determines that the current temperature Temp is higher than the temperature threshold TO, the process proceeds to step 308. When the controller 102 determines that the current temperature Temp is not higher than the temperature threshold TO, the process returns to step 304 to re-obtain the current temperature Temp of the non-volatile memory 108.

In step 308, the controller 102 directs the solid-state storage device 10 to enter state 1. Specifically, the temperature threshold TO represents the temperature threshold that activates the dynamic temperature control mechanism. When the solid-state storage device 10 enters state 1, the controller 102 refers to the temperature control state table (e.g., Table 1) to direct the clock generator 112 to reduce the frequencies of the first clock signal CLK1 and the second clock signal CLK2 to comply with the clock requirements for state 1.

In step 310, the temperature difference value T_{gap} and the temperature accumulation value T_{acc} are obtained. For example, the controller 102 can periodically receive the current temperature Temp of the non-volatile memory 108 reported by the temperature sensor 110, and the controller 102 can record the last received previous temperature Temp_pre in a register, and the temperature accumulation value T_{acc} calculated last time can be stored in the register. The temperature difference value T_{gap} and the temperature accumulation value T_{acc} can be respectively expressed by equation (1) and equation (2) as follows.

$${T}_{gap} = Temp - Temp\_pre \qquad ( 1 )$$

$${T}_{a c c} = {T}_{a c c} + {T}_{gap} \qquad ( 2 )$$

Specifically, the temperature difference value T_{gap} indicates the difference between the current temperature Temp and the previous temperature Temp_pre, and the temperature accumulation value T_{acc} indicates the currently accumulated value of the temperature difference value T_{gap}.

In step 312, the controller 102 determines whether the current state value is the maximum state value. That is, the controller 102 can determine whether the current state is the highest state (e.g., state 19). When the controller 102 determines that the current state value is the maximum state value (e.g., MAX), the process proceeds to step 324. When the controller 102 determines that the current state value is not the maximum state value, the process proceeds to step 314.

Specifically, when the controller 102 determines that the current state value is not the maximum state value, the controller 102 can determine the current temperature control state according to the state value shown in Table 2. Table 2 includes relationships between the temperature accumulation value T_{acc} and the increment of the state value. The steps in FIG. 3 corresponding to Table 2 are described as follows.

TABLE 2

| | Increment of |
|---|---|
| Range of T_{acc} | state value |
| T_{acc} <= N1 | 0 |
| N1 < T_{acc} <= N2 | 1 |
| T_{acc} > N2 | 3 |

In step 314, the controller 102 determines whether the temperature accumulation value T_{acc} is greater than a first value N1. When the controller 102 determines that the temperature accumulation value T_{acc} is greater than the first value N1, the process proceeds to step 316. When the controller 102 determines that the temperature accumulation value T_{acc} is not greater than the first value N1, the process returns to step 310. In some embodiments, the first value N1 is, for example, 3.

In step 316, the controller 102 determines whether the temperature accumulation value T_{acc} is greater than a second value N2. When the controller 102 determines that the temperature accumulation value T_{acc} is greater than the second value N2, the process proceeds to step 320. When the controller 102 determines that the temperature accumulation value T_{acc} is not greater than the second value N2, the process proceeds to step 318. In some embodiments, the second value N2 is, for example, equal to 5.

In step 318, the controller 102 increases the current state value by 1. If the state is continued from state 1, the temperature control state will switch from state 1 to state 2. In step 320, the controller 102 increases the current state value by 3. If the state is continued from state 1, the temperature control state will be switched from state 1 to state 4. In step 322, the controller 102 resets the temperature accumulation value T_{acc}, for example, resetting it to 0.

Specifically, in steps 314 to 322, the processes are performed based on the temperature accumulation value T_{acc} with reference to Table 2. If the temperature of the non-volatile memory 108 rises gradually, each time the controller 102 obtains the current temperature Temp of the non-volatile memory 108, the temperature difference value T_{gap} calculated by the controller 102 may be very small, and the temperature accumulation value T_{acc} will also increase slowly. If the temperature accumulation value T_{acc} is not large (e.g., not greater than the first value N1), the controller 102 can reobtain the current temperature Temp of the non-volatile memory 108 and recalculate the temperature difference value T_{gap} and the temperature accumulation value T_{acc}. When the temperature accumulation value T_{acc} is greater than the first value N1 and not greater than the second value N2, the controller 102 increases the current state value by 1 (e.g., step 318) to slowly change the temperature control state.

If the temperature of the non-volatile memory 108 rises rapidly, each time the controller obtains the current temperature Temp of the non-volatile memory 108, the temperature difference value T_{gap} calculated by the controller 102 is likely to be large, and the temperature accumulation The value T_{acc} will also increase rapidly. When the temperature accumulation value T_{acc} is greater than the second value N2, the controller 102 increases the current state value by 3 (e.g., step 320) to quickly change the temperature control state. After performing step 318 or 320 to increase the state value, the controller 102 will reset the temperature accumulation value T_{acc} to 0.

Accordingly, Table 2 can determine the relationship between the temperature change amplitude and the state value change amplitude. The present invention is not limited to the embodiment in Table 2. Those skilled in the art can set an appropriate state value increment table according to the practical conditions, as shown in another embodiment of Table 3, in which the values of N1 to N3 can also be set according to practical conditions.

TABLE 3

| | Increment of |
|---|---|
| Range of T_{acc} | state value |
| T_{acc} < N1 | 0 |
| N1 ≤ T_{acc} < N2 | 1 |
| N2 ≤ T_{acc} < N3 | 3 |
| T_{acc} ≥ N3 | 4 |

Similarly, when the controller 102 determines that the current state value is the maximum state value (e.g., MAX), the controller 102 can determine the current temperature control state with reference to the state value decrement table shown in Table 4. Table 4 includes the relationships between the temperature accumulation value T_{acc} and the decrement of the state value. The steps in FIG. 3 corresponding to Table 4 are described as follows.

TABLE 4

| | Decrement of |
|---|---|
| Range of T_{acc} | state value |
| T_{acc} < M1 | 1 |

In step 324, the controller 102 determines whether the temperature accumulation value T_{acc} is less than a third value M1. When controller 102 determines that the temperature accumulation value T_{acc} is less than the third value M1, the process proceeds to step 326. When the controller 102 determines that the temperature accumulation value T_{acc} is not less than the third value M1, the process returns to step 310. In some embodiments, the third value M1 is, for example, −2. Specifically, because the third value M1 is a negative value, if the temperature accumulation value T_{acc} is less than the third value M1, it means that the controller 102 has calculated a negative temperature difference T_{gap} at the current time, indicating that the current temperature Temp of the non-volatile memory 108 is lower than the previous temperature Temp_pre.

In step 326, the controller 102 decreases the current state value by 1. In step 328, the controller 102 resets the temperature accumulation value Tacc, for example, resetting it to 0. In step 330, the controller 102 determines whether the current state is state 0. When the controller 102 determines that the current state is state 0, the process returns to step 306. When the controller 102 determines that the current state is not state 0, the process returns to step 310.

Specifically, when lowering the temperature control state of the solid-state storage device 10, the controller 102 may adopt a more conservative strategy. Even if the calculated temperature accumulation value Tacc at the current time is much less than the third value M1, the controller 102 still only decrements the state value by 1 at one time. After the aforementioned calculation, if the temperature control state of the solid-state storage device is not state 0 (e.g., in any of states 1 to 19), the process in FIG. 3 can return to step 310, and then go through steps 312, 324, and 326 to reduce the state value.

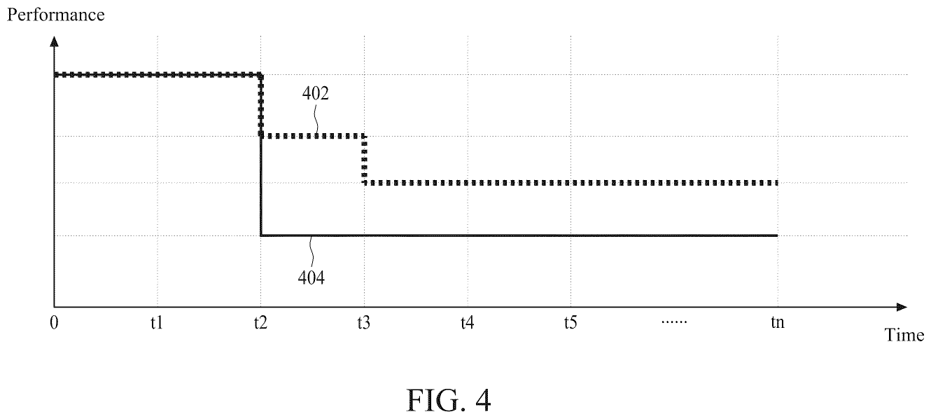

Similarly, according to the aforementioned embodiments, the results of FIG. 4 determine the relationship between temperature change amplitude and state value change amplitude. The present disclosure is not limited thereto, and one skilled in the art could set an appropriate state value decrement table according to the practical conditions, as shown in another embodiment in Table 5, where the values of M1 to M2 can also be set according to the practical conditions.

TABLE 5

| | Decrement of |
|---|---|
| Range of T_{acc} | state value |
| T_{acc} < M1 | 3 |
| M1 ≤ T_{acc} < M2 | 1 |

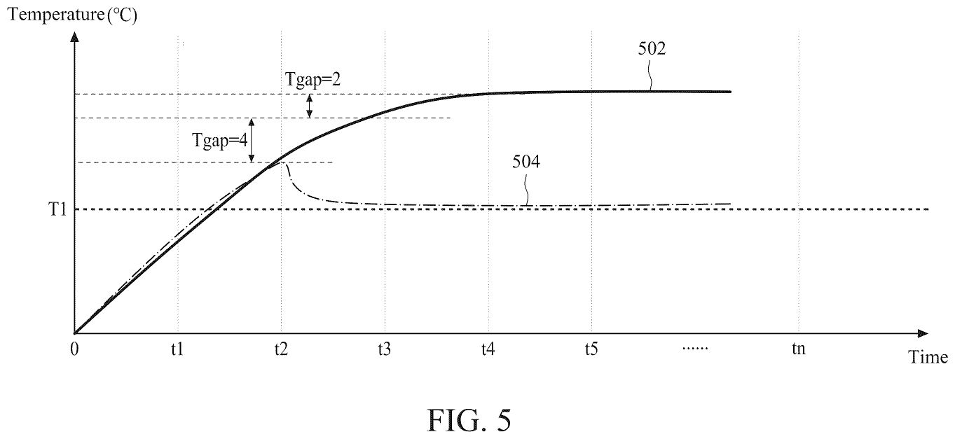

FIG. 4 is a diagram illustrating performance comparison between the methods in the embodiments of FIG. 2 and FIG. 3. FIG. 5 is a diagram illustrating temperature comparison between the methods in the embodiments of FIG. 2 and FIG. 3. Please refer to FIG. 2 to FIG. 5.

In some embodiments, when the solid-state storage device 10 uses the multistage temperature control method of FIG. 2 and the dynamic temperature control method of FIG. 3 under the same test conditions, the performance and temperature are measured separately to obtain FIGS. 4 and 5. Curves 402 and 404 in FIG. 4 represent the performance of the methods in FIGS. 3 and 2, respectively. Curves 502 and 504 in FIG. 5 represent the temperature of the methods in FIGS. 3 and 2, respectively.

Specifically, the dynamic temperature control method in FIG. 3 has a larger number of temperature control states, and the controller 102 determines the temperature control state based on the difference between the current temperature and the previous temperature of the non-volatile memory 108. In addition, the differences in overheating protection measures between two consecutive states in the dynamic temperature control method of FIG. 3 are more subtle.

The temperature control states of the multistage temperature control method in FIG. 2 are divided into only the light temperature control state, heavy temperature control state, first protection state, second protection state, and overheating state, and switching between the aforementioned temperature control states is determined by fixed temperature thresholds (e.g., temperature thresholds T0 to T5 shown in FIG. 2). In addition, the differences in overheat protection measures between consecutive states in the temperature control method of FIG. 2 are more obvious.

As shown in FIG. 4, at time t2, when the dynamic temperature control method of FIG. 3 enters state 3, the multistage temperature control method of FIG. 2 has entered the light temperature control state, which corresponds to state 8 in the dynamic temperature control method of FIG. 3. For example, the number of steps of the first clock signal CLK1 and the second clock signal CLK2 in state 3 is 4, and the number of steps of the first clock signal CLK1 and the second clock signal CLK2 in state 8 is 9. If the aforementioned steps represent the division ratios, the performance of the solid-state storage device 10 in state 3 is more than twice the performance in state 8.

At time t3, when the dynamic temperature control method of FIG. 3 enters state 4, the multistage temperature control method of FIG. 2 still maintains the light temperature control state. For example, the number of steps of the first clock signal CLK1 and the second clock signal CLK2 in state 4 is 5, and the number of steps of the first clock signal CLK1 and the second clock signal CLK2 in state 8 is 9. If the aforementioned steps represent the division ratios, the performance of the solid-state storage device 10 in state 3 is approximately twice the performance in state 8.

Regarding temperature control, please refer to FIG. 5. The multistage temperature control method of FIG. 2 directly enters the light temperature control state from time t2, and the temperature decreases directly, as shown by the temperature change of curve 504 between time t2 and time t3. Although the dynamic temperature control method of FIG. 3 enters state 3 and state 4 at time t2 and time t3, the cooling effect generated by the overheat protection measures in state 3 and state 4 is not strong. Therefore, as shown by the temperature change of curve 502 between time t2 and time t4, the main effect of the dynamic temperature control method of FIG. 3 is to slow down the rate of temperature rise, so that a certain level of performance can be maintained, and the situation of sacrificing performance to cool down due to rapid temperature rise can be avoided.

Therefore, compared to the multistage temperature control method of FIG. 2, the dynamic temperature control method of FIG. 3 has a higher temperature (as shown by curve 502 in FIG. 5), but has better performance (as shown by curve 402 in FIG. 4). The dynamic temperature control method of FIG. 3 can make adjustments to a temperature T at any time, control the range of temperature changes within a certain range, and correspondingly control the range of performance changes within a certain range, thereby balancing temperature and performance.

Although the present disclosure is disclosed herein with preferred embodiments, it is not intended to limit the scope of the present disclosure. Persons of ordinary skill in the art can make some modifications without departing from the spirit and scope of the present disclosure. Therefore, the scope of the present disclosure shall be determined by the appended claims.

What is claimed is:

1. A solid-state storage device, comprising:
a non-volatile memory;
a temperature sensor, configured to periodically detect a current temperature of the non-volatile memory; and
a controller, electrically connected to the non-volatile memory and the temperature sensor, and configured to periodically obtain the current temperature from the temperature sensor;
wherein the controller is configured to activate a dynamic temperature control mechanism of the solid-state storage device, and the dynamic temperature control mechanism comprises a temperature control state table having a plurality of temperature control states and their corresponding state values;
wherein the controller is further configured to calculate a temperature difference value between the current temperature and a previous temperature of the non-volatile memory, and accumulate the temperature difference value to obtain a temperature accumulation value; and
wherein the controller is further configured to determine a current temperature control state from the temperature control state table according to the temperature accumulation value.

2. The solid-state storage device of claim 1, wherein when the controller determines that the current temperature is higher than a first temperature threshold, the controller is configured to activate the dynamic temperature control mechanism of the solid-state storage device.

3. The solid-state storage device of claim 1, further comprising: a clock generator, configured to provide a first clock signal to the controller, and provide a second clock signal to the non-volatile memory, wherein a frequency of the first clock signal is higher than that of the second clock signal, and a number of steps of the first clock signal and the second clock signal is determined by the current temperature control state.

4. The solid-state storage device of claim 3, wherein the number of steps of the first clock signal and the second clock signal represent frequency division ratios of the first clock signal and the second clock signal.

5. The solid-state storage device of claim 3, wherein the number of steps of the first clock signal and the second clock signal represent frequency reduction ratios of the first clock signal and the second clock signal.

6. The solid-state storage device of claim 1, wherein when the controller activates the dynamic temperature control mechanism, the controller sets an initial temperature control state from the temperature control states within the temperature control state table as the current temperature control state.

7. The solid-state storage device of claim 1, wherein:
the dynamic temperature control mechanism further comprises a state increment table;
the controller is configured to determine whether a current state value corresponding to the current temperature control state is a maximum value;
when the controller determines that the current state value is not equal to the maximum value, the controller is further configured to determine a state value increment with reference to the state value increment table according to the temperature accumulation value; and
the controller is further configured to update the current state value by adding the state value increment to the current state value, and reset the temperature accumulation value.

8. The solid-state storage device of claim 7, wherein:
the dynamic temperature control mechanism further comprises a state value decrement table;
when the controller determines that the current state value is the maximum value, the controller is further configured to determine a state value decrement with reference to the state value decrement table according to the temperature accumulation value; and
the controller is further configured to update the current state value by subtracting the state value decrement from the current state value, and reset the temperature accumulation value.

9. A dynamic temperature control method, for use in a solid-state storage device, wherein the solid-state storage device comprises a controller, a temperature sensor, and a non-volatile memory, the method comprising:
utilizing the temperature sensor to periodically detect a current temperature of the non-volatile memory;
utilizing the controller to periodically obtain the current temperature from the temperature sensor;
utilizing the controller to activate a dynamic temperature control mechanism of the solid-state storage device, wherein the dynamic temperature control mechanism comprises a temperature control state table having a plurality of temperature control states and their corresponding state values;
utilizing the controller to calculate a temperature difference value between the current temperature and a previous temperature of the non-volatile memory, and to accumulate the temperature difference value to obtain a temperature accumulation value; and
utilizing the controller to determine a current temperature control state from the temperature control state table according to the temperature accumulation value.

10. The method of claim 9, further comprising: wherein when the controller determines that the current temperature is higher than a first temperature threshold, utilizing the controller to activate the dynamic temperature control mechanism of the solid-state storage device.

11. The method of claim 9, wherein the solid-state storage device further comprises a clock generator, and the method further comprises: utilizing the clock generator to provide a first clock signal to the controller, and to provide a second clock signal to the non-volatile memory, wherein a frequency of the first clock signal is higher than that of the second clock signal, and a number of steps of the first clock signal and the second clock signal is determined by the current temperature control state.

12. The method of claim 11, wherein the number of steps of the first clock signal and the second clock signal represent frequency division ratios of the first clock signal and the second clock signal.

13. The method of claim 11, wherein the number of steps of the first clock signal and the second clock signal represent frequency reduction ratios of the first clock signal and the second clock signal.

14. The method of claim 9, further comprising: when the controller activates the dynamic temperature control mechanism, utilizing the controller to set an initial temperature control state from the temperature control states within the temperature control state table as the current temperature control state.

15. The method of claim 9, wherein the dynamic temperature control mechanism further comprises a state increment table, and the method further comprises:
utilizing the controller to determine whether a current state value corresponding to the current temperature control state is a maximum value;
when the controller determines that the current state value is not equal to the maximum value, utilizing the controller to determine a state value increment with reference to the state value increment table according to the temperature accumulation value; and
utilizing the controller to update the current state value by adding the state value increment to the current state value, and to reset the temperature accumulation value.

16. The method of claim 15, wherein the dynamic temperature control mechanism further comprises a state value decrement table, and the method further comprises:
when the controller determines that the current state value is the maximum value, utilizing the controller to determine a state value decrement with reference to the state value decrement table according to the temperature accumulation value; and
utilizing the controller to update the current state value by subtracting the state value decrement from the current state value, and to reset the temperature accumulation value.
